(19) United States
(12) Patent Application Publication
(10) Pub. No.: US 2025/0253797 A1
(43) Pub. Date: Aug. 7, 2025

(54) ELECTRIC RATCHET WRENCH

(71) Applicant: BASSO INDUSTRY CORP., Taichung (TW)

(72) Inventors: Min-Hsu TSAI, Taichung (TW); Tsung-Han WU, Taichung (TW); Tian-Chi LAI, Taichung (TW); Ta-Chieh LIN, Taichung (TW); San-Yih SU, Taichung (TW)

(73) Assignee: BASSO INDUSTRY CORP., Taichung (TW)

(21) Appl. No.: 18/947,718

(22) Filed: Nov. 14, 2024

(30) Foreign Application Priority Data
Feb. 5, 2024 (TW) 113201383

(51) Int. Cl. H02P 29/032; B25B 21/00; H02H 7/085; H02P 7/03; H02P 7/29

(52) U.S. Cl. CPC H02P 29/032; B25B 21/004; H02H 7/085; H02P 7/05; H02P 7/29

(57) ABSTRACT

An electric ratchet wrench includes a control unit, a housing unit, and a driving unit. The control unit stores a plurality of parameter sets that correspond respectively to a plurality of operating modes related respectively to different sets of a torque and a rotational speed. The housing unit includes a housing, a trigger module configured to output a trigger signal when the trigger module is operated, and an operation module configured to output a mode signal for switching between the operating modes when the operation module is operated. The control unit is configured to, in response to receipt of the mode signal, set one of the operating modes as a current operating mode, and, in response to receipt of the trigger signal, output a control signal for controlling operation of a motor according to one of the parameter sets that corresponds to the current operating mode.

### CROSS-REFERENCE TO RELATED APPLICATION

This application claims priority to Taiwanese Utility Model Patent Application No. 113201383, filed on Feb. 5, 2024, the entire disclosure of which is incorporated by reference herein.

### FIELD

The disclosure relates to a handheld power tool, and more particularly to an electric ratchet wrench.

### BACKGROUND

A ratchet wrench is a tool used for turning bolts, nuts or sockets, and has the characteristic of being able to apply force at a narrow angle. Conventional electric ratchet wrenches can only output the same torque with the same rotational speed, where the torque and the rotational speed cannot be adjusted according to needs. In order to solve the above issue, a conventional speed-adjustable electric ratchet wrench equipped with a mechanical speed change mechanism has been developed. The mechanical speed change mechanism can be manually operated by a user to change a rotational speed outputted by the conventional speed-adjustable electric ratchet wrench. However, a shortcoming of the mechanical speed change mechanism is that, when the rotational speed is reduced, the torque will be increased, which may easily cause damage to a workpiece or a bolt that is operated upon. Furthermore, the mechanical speed change mechanism will increase the complexity of the structure of the conventional speed-adjustable electric ratchet wrench, resulting in increased size, weight, noise, and cost. The mechanical speed change mechanism will also increase wear and tear of some components of the conventional speed-adjustable electric ratchet wrench, thereby increasing a failure rate and maintenance costs of the conventional speed-adjustable electric ratchet wrench.

### SUMMARY

Therefore, an object of the disclosure is to provide an electric ratchet wrench that can alleviate at least one of the drawbacks of the prior art.

According to the disclosure, the electric ratchet wrench includes a control unit, a housing unit, and a driving unit.

The control unit stores a plurality of parameter sets that correspond respectively to a plurality of operating modes. The plurality of operating modes are related respectively to different sets of a torque and a rotational speed.

The housing unit includes a housing, a trigger module and an operation module. The trigger module is disposed on the housing, is electrically connected to the control unit, and is configured to output a trigger signal to the control unit when the trigger module is operated. The operation module is disposed on the housing, is electrically connected to the control unit, and is configured to output a mode signal the control unit to switch between the plurality of operating modes when the operation module is operated.

The driving unit is electrically connected to the control unit, and includes a motor, a reduction drive, a driving mechanism, and a pawl assembly. The motor is disposed in the housing and has an output shaft. The motor generates a rotational driving force that is transferred out of the motor through the output shaft when the motor is operating. The reduction drive is connected to the output shaft, and is configured to transmit the rotational driving force outputted by the output shaft. The driving mechanism is connected to the reduction drive, and is configured to be driven by the reduction drive to output a rotational motion. The pawl assembly is connected to the driving mechanism, and is configured to restrict a rotational direction of the rotational motion outputted by the driving mechanism.

The control unit is configured to, in response to receipt of the mode signal from the operation module, set one of the plurality of operating modes as a current operating mode. The control unit is further configured to, in response to receipt of the trigger signal from the trigger module, output a control signal to the motor for controlling operation of the motor according to one of the plurality of parameter sets that corresponds to the current operating mode.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating an electric ratchet wrench according to an embodiment of the present disclosure.

FIG. 2 is a cross-sectional view of the electric ratchet wrench according to an embodiment of the present disclosure.

FIG. 3 is a block diagram of the electric ratchet wrench according to an embodiment of the present disclosure.

FIG. 4 is a schematic diagram illustrating an example of an operation module of the electric ratchet wrench according to an embodiment of the present disclosure.

FIG. 5 is a perspective view illustrating another example of the operation module.

FIG. 6 is a perspective view illustrating another example of the operation module.

FIG. 7 is a fragmentary schematic diagram illustrating a direction switch module of the electric ratchet wrench according to an embodiment of the present disclosure.

FIG. 8 is a fragmentary schematic diagram illustrating a variation of the direction switch module according to an embodiment of the present disclosure.

FIG. 9 is a cross-sectional view of the electric ratchet wrench for illustrating an example of a driving mechanism of the electric ratchet wrench.

FIG. 10 is a flow chart of an operation method of the electric ratchet wrench according to an embodiment of the present disclosure.

FIGS. 11 to 16 are schematic diagrams illustrating different examples of the operation module, respectively.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

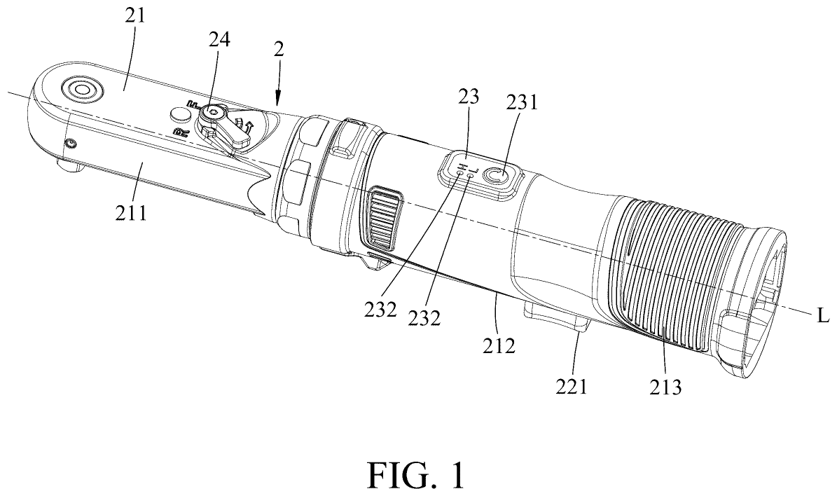

Referring to FIGS. 1, 2 and 3, an electric ratchet wrench according to an embodiment of the present disclosure includes a housing unit 2, a power supply unit 3, a driving unit 4, a detecting unit 5, and a control unit 6.

The housing unit 2 includes a housing 21, a trigger module 22, an operation module 23, and a direction switch module 24. The housing 21 has a driving head section 211, an intermediate section 212 and a grip section 213 that are arranged sequentially along an axis (L). The trigger module 22 includes a trigger 221 that is disposed on the housing 21, and a trigger detection circuit 222 that is electrically connected to the control unit 6. The trigger detection circuit 222 is configured to detect a degree of actuation to which the trigger 221 is actuated, and to output a trigger signal that indicates the degree of actuation of the trigger 221 to the control unit 6 when the trigger 221 is actuated. For example, the trigger detection circuit 222 includes a variable resistor (not shown) connected to the trigger 221, the trigger 21 changes a resistance of the variable resistor when it is actuated, and the control circuit 6 is able to determine the degree of actuation to which the trigger 221 is actuated by obtaining a change in the resistance of the variable resistor.

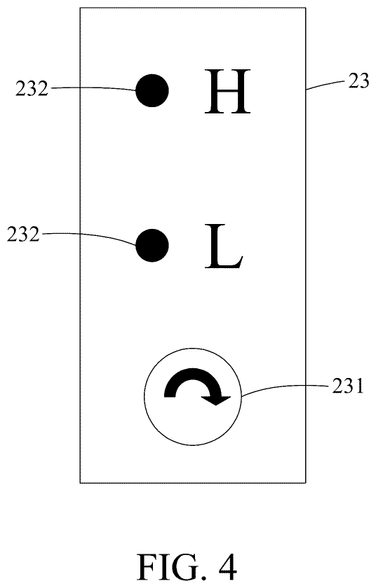

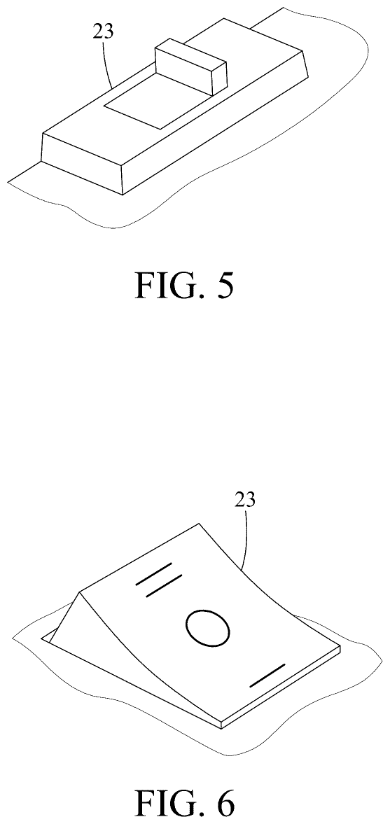

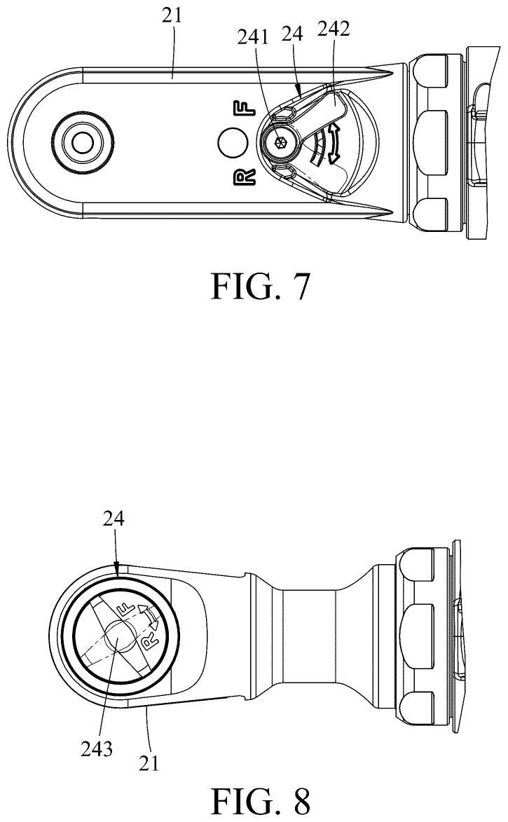

The operation module 23 is disposed on an outer surface of the housing 21. For example, the operation module 23 is disposed on the intermediate section 212 of the housing 21. The operation module 23 is electrically connected to the control unit 6, and outputs a mode signal to the control unit 6 for the control unit 6 to switch between a plurality of operating modes when the operation module 23 is operated. Referring to FIGS. 1, 3 and 4, the operation module 23 includes, for example, a switch button 231 that is disposed on the housing 21, and two indicators 232 that correspond respectively to two operating modes shown in FIG. 4. For example, the operating modes include a high performance mode (hereinafter referred to as “the H mode”) and a low performance mode (hereinafter referred to as “the L mode”, and the indicators 232 corresponding respectively to two symbols “H” and “L” respectively refer to the H mode and the L mode. When the switch button 231 is operated, the switch button 231 outputs the mode signal. In this example, since there are only two operating modes (the H mode and the L mode), when the control unit 6 receives the mode signal, the control unit 6 toggles between the two operating modes and controls one of the indicators 232 that corresponds to one of the operating modes the control unit 6 is currently operating in to emit light. FIG. 5 illustrates another example of the operation module 23, where the operation module 23 is exemplified as a toggle switch that is able to toggle between a first position that corresponds to one of the two operating modes and a second position that corresponds to another one of the two operating modes. FIG. 6 illustrates yet another example of the operation module 23, where the operation module 23 is a three-stage switch. It should be noted that the operation module 23 is not limited to the examples given in this disclosure.

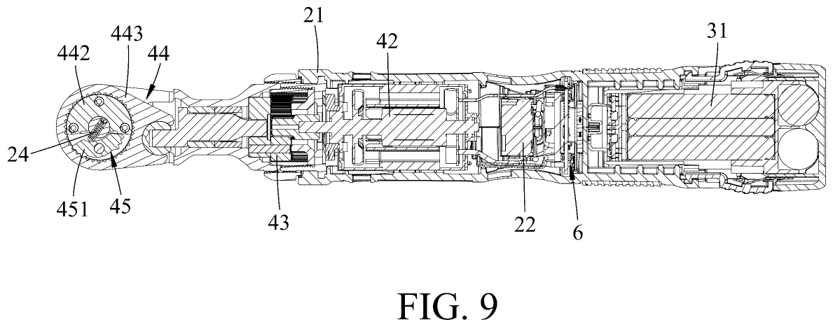

Referring to FIG. 7, the direction switch module 24 is disposed on the housing 21. The direction switch module 24 includes a pivot 241 and a lever 242 that is pivoted on the pivot 241 to toggle between a forward rotation position represented by solid lines, and a reverse rotation position represented by dashed lines. The lever 242 is operable by a user to toggle between the forward rotation position and the reverse rotation position.

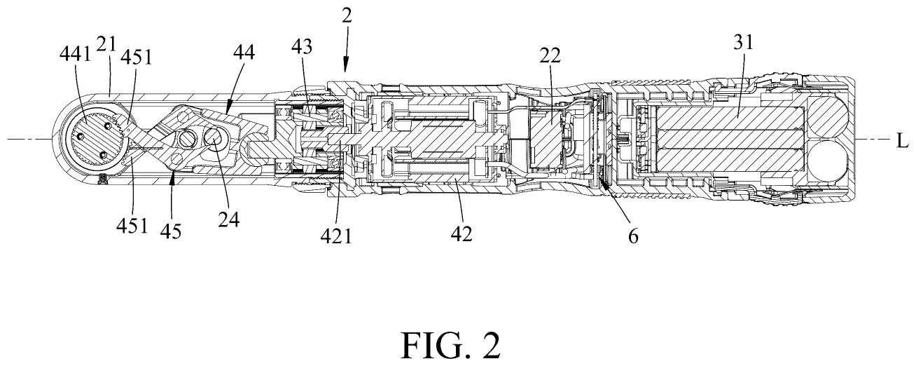

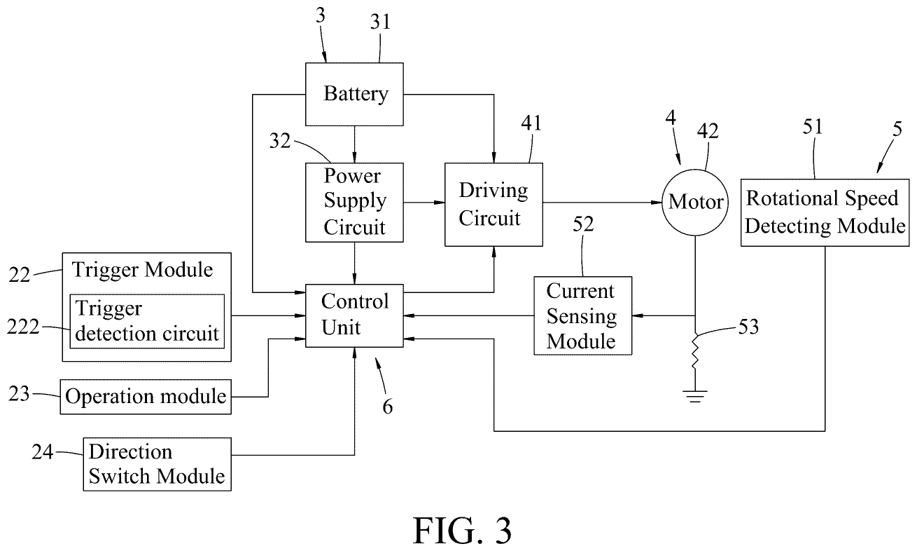

Referring to FIGS. 2 and 3, the power supply unit 3 includes a battery 31 disposed in the housing 21, and a power supply circuit 32 electrically connected to the battery 31. The power supply circuit 32 stabilizes and regulates a power supplied by the battery 31 and then provides the power to an internal circuit (not shown) of the electric ratchet wrench of this disclosure. The power supply circuit 32 includes, for example, a low-dropout regulator (LDO) (not shown) for providing a stabilized and regulated power supply.

The driving unit 4 is electrically connected to the control unit 6 and includes a driving circuit 41, a motor 42 disposed in the housing 21 and having an output shaft 421, a reduction drive 43 connected to the output shaft 421, a driving mechanism 44 connected to the reduction drive 43 and having a driving gear 441, and a pawl assembly 45 connected to the driving mechanism 44. The driving circuit 41 is configured to receive a control signal in a form of a pulse-width modulation (PWM) signal outputted by the control unit 6 and to drive the motor 42 to rotate according to a duty cycle of the PWM signal. The motor 42 may be exemplified as, for example, a brushless direct current motor (BLDC). When the motor 42 is driven to rotate, the motor 42 generates a rotational driving force that is transferred out of the motor 42 through the output shaft 421. The reduction drive 43 then transmits the rotational driving force outputted by the output shaft 421. The driving mechanism 44 is driven by the reduction drive 43 to output a rotational motion. Specifically, by virtue of the reduction drive 43, the driving mechanism 44 is driven to rotate at a reduced rotational speed relative to a rotational speed of the output shaft 421 when the motor 42 is operated. The reduction drive 43 may be exemplified by, for example, a planetary gear set. The operation module 23 is disposed at a position that is aligned radially with the motor 42 (see FIGS. 1 and 2).

Referring to FIGS. 2 and 7, the pawl assembly 45 is configured to restrict a rotational direction of the rotational motion outputted by the driving mechanism 44. Specifically, the pawl assembly 45 includes two pawl arms 451 that are connected to the direction switch module 24. When the lever 242 of the direction switch module 24 is in the forward rotation position, one of the pawl arms 451 is caused to engage with the driving gear 441, and the other one of the pawl arms 451 is caused to disengage from the driving gear 441. This configuration restricts a rotational direction of the driving gear 441 (i.e., the rotational direction of the rotational motion outputted by the driving mechanism 44) to only be able to rotate in a clockwise direction (relative to the viewing angle of FIG. 2). When the lever 242 of the direction switch module 24 is in the reverse rotation position, said one of the pawl arms 451 is now caused to disengage from the driving gear 441, and said the other one of the pawl arms 451 is now caused to engage with the driving gear 441 (as shown in FIG. 2). This configuration restricts the rotational direction of the driving gear 441 to only be able to rotate in a counter-clockwise direction (relative to the viewing angle of FIG. 2). Since operation of the pawl assembly 45 is well known in the art, further descriptions thereof will be omitted for the sake of brevity.

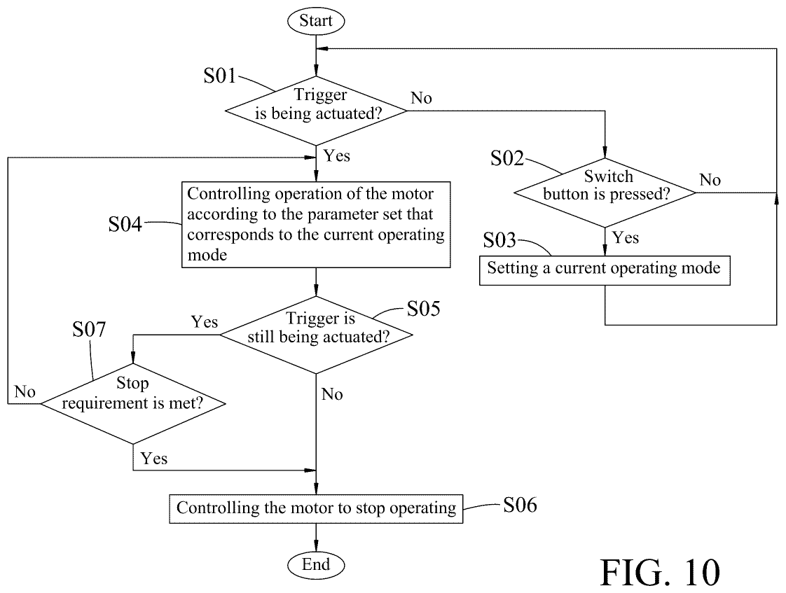

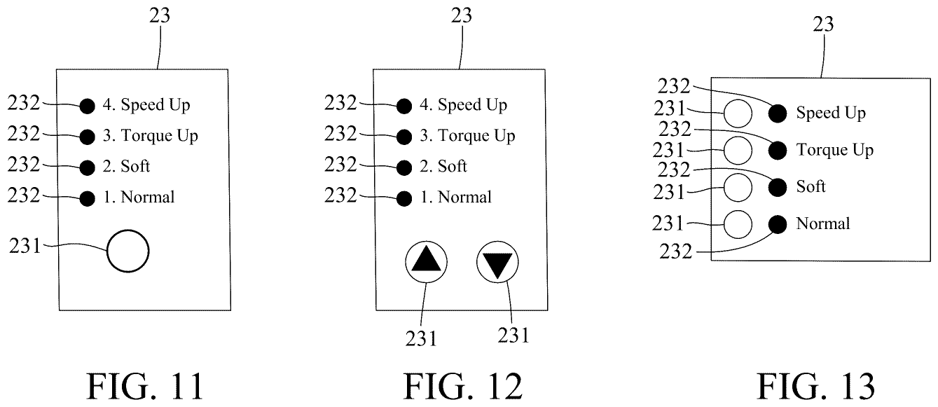

Referring to FIGS. 8 and 9, a variation of the direction switch module 24 is provided. In this variation, the direction switch module 24 includes a knob 243 instead of the lever 242, and toggling between the forward rotation position and the reverse rotation position is achieved by turning the knob 243. A variation of the driving unit 4 is also provided (see FIG. 9), where the driving mechanism 44 includes an anvil gear 442 and a toothed ring 443 that surrounds and engages the anvil gear 442, and the pawl assembly 45 includes a pawl arm 451 that has two ends. The pawl arm 451 is attached to the anvil gear 442, and is caused to rotate by the direction switch module 24. The two ends of the pawl arm 451 are caused to engage with the toothed ring 443 one at a time. When the knob 243 is turned to the forward rotation position (i.e., a position of the knob 243 represented in solid lines as shown in FIG. 8), one of the two ends of the pawl arm 451 engages with the toothed ring 443, which restricts a rotational direction of the anvil gear 442 to only be able to rotate in the clockwise direction (relative to the viewing angle of FIG. 9). When the knob 243 is turned to the reverse rotation position (i.e., the position of the knob 243 represented in dashed lines as shown in FIG. 8), another one of the two ends of the pawl arm 451 engages with the toothed ring 443 (as shown in FIG. 9), which restricts the rotational direction of the anvil gear 442 to only be able to rotate in the counter-clockwise direction (relative to the viewing angle of FIG. 9). Since operations of these variations of the direction switch module 24 and the driving unit 4 are well known in the art, further descriptions thereof will be omitted for the sake of brevity.

Referring to FIG. 3, the detecting unit 5 includes a rotational speed detecting module 51 and a current sensing module 52.

The rotational speed detecting module 51 is configured for detecting a rotational speed of the motor 42, and outputs the rotational speed of the motor 42 thus detected to the control unit 6. The rotational speed detecting module 51 may be exemplified by using, for example, a Hall sensor.

The current sensing module 52 is electrically connected to the control unit 6. In this embodiment, the current sensing module 52 is used in cooperation with a sensing resistor 53 for sensing a current of the motor 42. The current sensing module 52 outputs a detection signal that indicates the current of the motor 42 to the control unit 6. With this configuration, the control unit 6 is able to monitor the current of the motor 42.

The control unit 6 may be realized by an integrated circuit that has functions such as analog-to-digital (A/D) conversion, input-output (I/O) detection, pulse-width modulation (PWM) output, and rotational speed calculation. For example, the control unit 6 may be exemplified by a microcontroller (MC) or a microcontroller unit (MCU). The control unit 6 is electrically connected to the trigger module 22 for receiving the trigger signal therefrom, the operation module 23 for receiving the mode signal therefrom, the direction switch module 24, the driving unit 4 and the detecting unit 5. The control unit 6 stores a plurality of parameter sets that correspond respectively to the operating modes. The operating modes are related respectively to different sets of a torque and a rotational speed. Each of the parameter sets includes at least one current threshold value, at least one duty cycle upper limit, and a predetermined time length. The current threshold value may be set according to an actual torque requirement. The greater the current threshold value, the greater the torque that the motor 42 may reach when tightening a fastener (e.g., a bolt or a nut). The duty cycle upper limit may be set according to an actual rotational speed requirement. The greater the duty cycle upper limit, the greater the rotational speed that the motor 42 may achieve. The predetermined time length may be set to be the same for each of the operating modes, or may be set according to the needs of each of the operating modes. The greater the predetermined time length, the greater the torque that the motor 42 may achieve. When the control unit 6 receives the mode signal from the operation module 23, the control unit 6 sets one of the operating modes as a current operating mode. When the control unit 6 receives the trigger signal from the trigger module 22, the control unit 6 outputs the control signal to the motor 42 for controlling operation of the motor 42 according to one of the parameter sets that corresponds to the current operating mode.

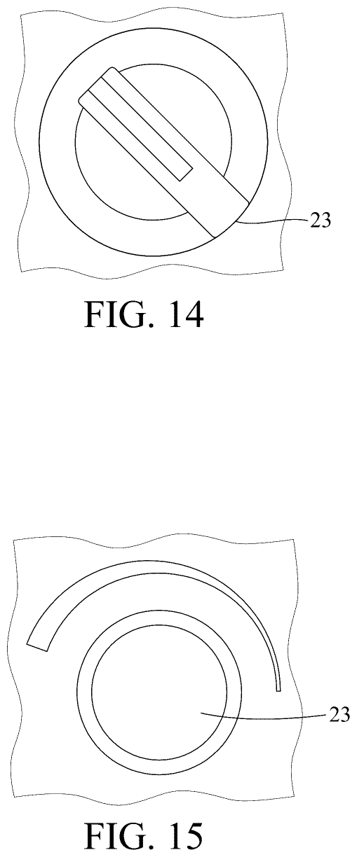

Referring to FIG. 10, when the electric ratchet wrench according to this disclosure is powered on, the electric ratchet wrench executes step S01. In step S01, the control unit 6 determines whether the trigger 221 is being actuated based on whether the trigger signal is received from the trigger module 22. When the control unit 6 determines that the trigger 221 is not being actuated (i.e., the control unit 6 did not receive the trigger signal from the trigger module 22), the flow goes to step S02. In step S02, the control unit 6 determines whether the switch button 231 is pressed based on whether the mode signal is received from the operation module 23. When the control unit 6 determines that the switch button 231 is not pressed (the control unit 6 did not receive the mode signal from the operation module 23), the flow goes back to step S01. When the control unit 6 determines that the switch button 231 is pressed (i.e., the control unit 6 receives the mode signal from the operation module 23), the flow goes to step S03. In step S03, the control unit 6 sets one of the operating modes as the current operating mode, and controls one of the indicators 232 that corresponds to the current operating mode to emit light. For example, when the current operating mode is currently the H mode, and the control unit 6 receives the mode signal (i.e., the switch button 231 is pressed) from the operation module 23, the control unit 6 sets the L mode as the current operating mode, and controls one of the indicators 232 that corresponds to the L mode to emit light. On the other hand, when the current operating mode is currently the L mode, and the control unit 6 receives the mode signal from the operation module 23, the control unit 6 sets the H mode as the current operating mode, and controls one of the indicators 232 that corresponds to the H mode to emit light. Then, the flow goes back to step S01.

When the control unit 6 determines, in step S01, that the trigger 221 is being actuated (i.e., the control unit 6 receives the trigger signal from the trigger module 22), the flow goes to step S04. In step S04, the control unit 6 outputs the control signal to the motor 42 according to one of the parameter sets that corresponds to the current operating mode. In this embodiment, when the electric ratchet wrench is powered on and the switch button 231 is not pressed, the H mode is set as the current operating mode by default. In step S04, the control unit 6 controls the operation of the motor 42 by outputting the control signal having a duty cycle not exceeding the duty cycle upper limit of the parameter set that corresponds to the current operating mode. Specifically, the control unit 6, according to the trigger signal, controls the motor 42 to operate in a rotational speed that is positively correlated to the degree of actuation of the trigger 221 when the duty cycle of the control signal is below the duty cycle upper limit of the parameter set that corresponds to the current operating mode.

When the motor 42 is operating, the control unit 6 continues to determine whether the trigger 221 is still being actuated (step S05). If the control unit 6 determines that the trigger 221 has stopped being actuated, which means that the user has released the trigger 221, the flow goes to step S06. In step S06, the control unit 6 controls the motor 42 to stop operating. If the determination in step S05 is affirmative, the flow goes to step S07. In step S07, the control unit 6 determines whether a stop requirement is met. If the determination in step S07 is affirmative, the flow goes to step S06, and the control unit 6 controls the motor 42 to stop operating. The flow goes back to step S04 when the determination made in step S07 is negative, and the control unit 6 continues to control the motor 42 to operate according to the parameter set that corresponds to the current operating mode in step S04. The stop requirement is the current of the motor 42 exceeding the current threshold value of the parameter set that corresponds to the current operating mode for the predetermined time length of the same parameter set, which indicates that the fastener has been tightened. When the control unit 6 determines that the stop requirement is met, the control unit 6 controls the motor 42 to stop operating (step S06) in order to avoid damaging or deforming a workpiece.

Operations of the H mode and the L mode are illustrated below.

For example, one of the parameter sets that corresponds to the H mode includes a first current threshold value (hereinafter referred to as “l_high”), a first duty cycle upper limit, and a first predetermined time length. In this embodiment, the first duty cycle upper limit is 100%. When the H mode is currently set as the current operating mode and the control unit 6 receives the trigger signal from the trigger module 22, the control unit 6 executes step S04. In step S04, the control unit 6 outputs the control signal having a duty cycle not exceeding 100% for controlling the operation of the motor 42. When the duty cycle of the control signal is below 100%, the control unit 6 controls the motor 42 to operate in the rotational speed that is positively correlated to the degree of actuation of the trigger 221. When the control unit 6 determines that the stop requirement is met, that is, when the control unit 6 determines that the current of the motor 42 exceeds the l_high for the first predetermined time length, the control unit 6 controls the motor 42 to stop operating.

For example, one of the parameter sets that corresponds to the L mode includes a second current threshold value (hereinafter referred to as “l_low”), a second duty cycle upper limit, and a second predetermined time length, where l_low<l_high. In this embodiment, the second duty cycle upper limit is lower than the first duty cycle upper limit and is defined by N %, where N<100. When the L mode is currently set as the current operating mode and the control unit 6 receives the trigger signal from the trigger module 22, the control unit 6 executes step S04. In step S04, the control unit 6 outputs the control signal having a duty cycle not exceeding N % for controlling the operation of the motor 42. When the duty cycle of the control signal is below N %, the control unit 6 controls the motor 42 to operate in the rotational speed that is positively correlated to the degree of actuation of the trigger 221. When the control unit 6 determines that the stop requirement is met, that is, when the control unit 6 determines that the current of the motor 42 exceeds the l_low for the second predetermined time length, the control unit 6 controls the motor 42 to stop operating.

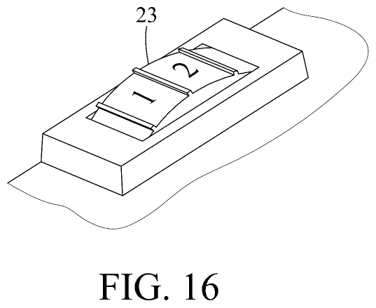

Referring to FIGS. 3, 10, and 11, in some embodiments, the operating modes include a normal mode, a soft mode, a torque-up mode, and a speed-up mode. An example of the operation module 23 includes a switch button 231, and four indicators 232 that correspond respectively to the four operating modes as shown in FIG. 11. Some examples of the operation module 23 according to this disclosure may include two switch buttons 231 (see FIG. 12) for respectively toggling up and down among the operating modes, or four switch buttons 231 (see FIG. 13) that correspond respectively with the operating modes for a user to be able to directly select a desired one of the operating modes to be set as the current operating mode. In other embodiments, the operation module 23 may be exemplified as a rotary knob to switch among the operating modes as shown in FIGS. 14 and 15, or as a rotary knob-type variable resistor as shown in FIG. 16.

Referring to FIGS. 1, 3, 10 and 11, operations regarding the four operating modes (i.e., normal mode, a soft mode, a torque-up mode, and a speed-up mode) will be described below. The normal mode and the soft mode are the same as the H mode and the L mode, respectively. Therefore, descriptions of the normal mode and the soft mode will be omitted hereinafter for the sake of brevity.

For example, one of the parameter sets that corresponds to the torque-up mode includes a third current threshold value, a fourth current threshold value (hereinafter referred to as “l_medium”), a third duty cycle upper limit, a fourth duty cycle upper limit, and a third predetermined time length. In this embodiment, the third current threshold value may be, for example, the same as l_low, or may be determined according to a torque requirement during actual application. The third duty cycle upper limit may be, for example, the same as the second duty cycle upper limit (i.e., N %), or may be determined according to a speed requirement during actual application. Specifically, l_low<l_medium<l_high. The fourth duty cycle upper limit is lower than the first duty cycle upper limit, but is higher than the third duty cycle upper limit. In this embodiment, the fourth duty cycle upper limit may be defined by M %, where N<M<100.

When the torque-up mode is currently set as the current operating mode and the control unit 6 receives the trigger signal from the trigger module 22, the control unit 6 executes step S04. In step S04, the control unit 6 first outputs the control signal having a duty cycle not exceeding the third duty cycle upper limit (i.e., N %) for controlling the operation of the motor 42. When the duty cycle of the control signal is below N %, the control unit 6 controls the motor 42 to operate in the rotational speed that is positively correlated to the degree of actuation of the trigger 221. When the control unit 6 determines that the current of the motor 42 exceeds the third current threshold value (i.e., l_low), and the rotational speed of the motor 42 is reduced, the control unit 6 then increases a duty cycle of the control signal not exceeding the fourth duty cycle upper limit (i.e., M %) and outputs the control signal for controlling the motor 42 to continue to operate. At this time, when the duty cycle of the control signal is below M %, the control unit 6 controls the motor 42 to operate in the rotational speed that is positively correlated to the degree of actuation of the trigger 221. When the control unit 6 determines that the stop requirement is met, that is, when the control unit 6 determines that the current of the motor 42 exceeds the l_medium for the third predetermined time length, the control unit 6 controls the motor 42 to stop operating.

For example, one of the parameter sets that corresponds to the speed-up mode includes a fifth current threshold value, a fifth duty cycle upper limit, and a fourth predetermined time length. In this embodiment, the fifth current threshold value may be, for example, the same as l_low, or may be determined according to the torque requirement during actual application. The fifth duty cycle upper limit may be, for example, the same as the first duty cycle upper limit (i.e., 100%), or may be determined according to the speed requirement during actual application.

When the speed-up mode is currently set as the current operating mode and the control unit 6 receives the trigger signal from the trigger module 22, the control unit 6 executes step S04. In step S04, the control unit 6 outputs the control signal having a duty cycle not exceeding the fifth duty cycle upper limit (i.e., 100%) for controlling the operation of the motor 42. When the duty cycle of the control signal is below 100%, the control unit 6 controls the motor 42 to operate in the rotational speed that is positively correlated to the degree of actuation of the trigger 221. When the control unit 6 determines that the stop requirement is met, that is, when the control unit 6 determines that the current of the motor 42 exceeds the l_low for the fourth predetermined time length, the control unit 6 controls the motor 42 to stop operating.

In summary, the electric ratchet wrench according to this disclosure includes the trigger module 22, the operation module 23, the driving unit 4, the detecting unit 5, and the control unit 6 that is able to switch among the operating modes. The control unit 6 outputs the control signal that corresponds to the current operating mode for controlling the operation of the motor 42. By virtue of the aforementioned configurations, the electric ratchet wrench according to this disclosure is able to produce rotational motion of different torque and speed. Therefore, a user may select an appropriate torque and speed according to the needs of the user, and may prevent damaging or deforming the workpiece when the user is working on the workpiece using the electric ratchet wrench of this disclosure. In addition, by way of electronically switching among the operating modes, the electric ratchet wrench of this disclosure provides advantages of fast switching without increasing the complexity of the structure of the electric ratchet wrench, the size, the weight, and the noise of the electric ratchet wrench. Furthermore, the cost, the failure rate, and the maintenance costs are also lowered. Therefore, the electric ratchet wrench of this disclosure has better market potential.

To add on, by virtue of the control unit 6 being able to control the motor 42 to operate in the rotational speed that is positively correlated to the degree of actuation of the trigger 221, a user is able to control the rotational speed of the motor 42 by controlling the degree of actuation of the trigger 221, thereby providing a more intuitive control over the rotational speed of the motor 42.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An electric ratchet wrench, comprising:
a control unit storing a plurality of parameter sets that correspond respectively to a plurality of operating modes, the plurality of operating modes being related respectively to different sets of a torque and a rotational speed;
a housing unit including
a housing,
a trigger module disposed on said housing, electrically connected to said control unit, and configured to output a trigger signal to said control unit when said trigger module is operated, and
an operation module disposed on said housing, electrically connected to said control unit, and configured to output a mode signal to said control unit for said control unit to switch between the plurality of operating modes when said operation module is operated; and
a driving unit electrically connected to said control unit, and including
a motor disposed in said housing, having an output shaft, said motor generating a rotational driving force that is transferred out of said motor through said output shaft when said motor is operating,
a reduction drive connected to said output shaft, and configured to transmit the rotational driving force outputted by said output shaft,
a driving mechanism connected to said reduction drive, and configured to be driven by said reduction drive to output a rotational motion, and
a pawl assembly connected to said driving mechanism, and configured to restrict a rotational direction of the rotational motion outputted by said driving mechanism;
wherein said control unit is configured to, in response to receipt of the mode signal from said operation module, set one of the plurality of operating modes as a current operating mode,
wherein said control unit is further configured to, in response to receipt of the trigger signal from said trigger module, output a control signal to said motor for controlling operation of said motor according to one the plurality of parameter sets that corresponds to the current operating mode.

2. The electric ratchet wrench as claimed in claim 1, further comprising a detecting unit including a current sensing module that is electrically connected to said control unit, and that is configured to sense a current of said motor and to output a detection signal indicating the current of said motor to said control unit,
wherein each of the plurality of parameter sets includes a current threshold value, and said control unit is further configured to control said motor to stop operating when the current of said motor exceeds the current threshold value of said one of the plurality of parameter sets that corresponds to the current operating mode for a predetermined time length.

3. The electric ratchet wrench as claimed in claim 1, wherein the trigger signal indicates a degree of actuation to which said trigger module is actuated, each of the plurality of parameter sets includes a duty cycle upper limit, and said control unit is configured to output the control signal having a duty cycle not exceeding the duty cycle upper limit of said one of the plurality of parameter sets that corresponds to the current operating mode for controlling the operation of said motor, and
wherein said control unit is further configured to, according to the trigger signal, control said motor to operate in a rotational speed that is positively correlated to the degree of actuation when the duty cycle of the control signal is below the duty cycle upper limit of said one of the plurality of parameter sets that corresponds to the current operating mode.

4. The electric ratchet wrench as claimed in claim 1, further comprising a detecting unit including a current sensing module that is electrically connected to said control unit, and that is configured to sense a current of said motor and to output a detection signal indicating the current of said motor to said control unit,
wherein the plurality of operating modes include a high performance mode and a low performance mode, one of the plurality of parameter sets that corresponds to the high performance mode including a first current threshold value, a first duty cycle upper limit, and a first predetermined time length, another one of the plurality of parameter sets that corresponds to the low performance mode including a second current threshold value, a second duty cycle upper limit, and a second predetermined time length,
wherein the first current threshold value is higher than the second current threshold value, and the first duty cycle upper limit is higher than the second duty cycle upper limit,
wherein said control unit is configured, when the high performance mode is set as the current operating mode, to output the control signal having a duty cycle not exceeding the first duty cycle upper limit for controlling operation of said motor, and to control said motor to stop operating when the current of said motor exceeds the first current threshold for the first predetermined time length,
wherein said control unit is further configured, when the low performance mode is set as the current operating mode, to output the control signal having a duty cycle not exceeding the second duty cycle upper limit for controlling operation of said motor, and to control said motor to stop operating when the current of said motor exceeds the second current threshold for the second predetermined time length.

5. The electric ratchet wrench as claimed in claim 4, wherein said detecting unit further includes a rotational speed detecting module for detecting a rotational speed of said motor,
wherein the plurality of operating modes further include a torque-up mode, one of the plurality of parameter sets that corresponds to the torque-up mode including a third current threshold value, a fourth current threshold value, a third duty cycle upper limit, a fourth duty cycle upper limit, and a third predetermined time length,
wherein the first current threshold value is higher than the fourth current threshold value, and the fourth current threshold value is higher than the third current threshold value,
wherein the first duty cycle upper limit is higher than the fourth duty cycle upper limit, and the fourth duty cycle upper limit is higher than the third duty cycle upper limit,
wherein said control unit is configured, when the torque-up mode is set as the current operating mode, to first output the control signal having a duty cycle not exceeding the third duty cycle upper limit for controlling operation of said motor, to increase a duty cycle of the control signal not exceeding the fourth duty cycle upper limit and to output the control signal for controlling said motor to continue operating when the current of said motor exceeds the third current threshold value and the rotational speed of said motor is reduced, and to control said motor to stop operating when the current of said motor exceeds the fourth current threshold value for the third predetermined time length.

6. The electric ratchet wrench as claimed in claim 4, wherein plurality of the operating modes further include a speed-up mode, one of the plurality of parameter sets that corresponds to the speed-up mode including a third current threshold value, a third duty cycle upper limit, and a third predetermined time length,
wherein the third current threshold value is lower than the first current threshold value, and the third duty cycle upper limit is higher than the second duty cycle upper limit,
wherein said control unit is configured, when the speed-up mode is set as the current operating mode, to output the control signal having a duty cycle not exceeding the third duty cycle upper limit for controlling operation of said motor, and to control said motor to stop operating when the current of said motor exceeds the third current threshold value for the third predetermined time length.

7. The electric ratchet wrench as claimed in claim 1, wherein said operation module includes a switch button that is disposed on said housing and that is configured to output the mode signal when being operated.

8. The electric ratchet wrench as claimed in claim 1, wherein said operation module is disposed on an outer surface of said housing at a position that is aligned radially with said motor.

9. The electric ratchet wrench as claimed in claim 1, wherein said housing has a driving head section, an intermediate section and a grip section that are arranged sequentially along an axis, and said operation module is disposed on said intermediate section.
